(19) United States
(12) Patent Application Publication
(10) Pub. No.: US 2005/0108270 A1
(43) Pub. Date: May 19, 2005

(54) Program presentation in an electronic program guide

(75) Inventors: Michael Heesemans, Eindhoven (NL); Ronaldus Hermanus Theodorus Oosterholt, Eindhoven (NL); Guy James Roberts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/512,116

(22) PCT Filed: Apr. 15, 2003
(86) PCT No.: PCT/IB03/01606

(30) Foreign Application Priority Data
Apr. 26, 2002 (EP) 02076670.5

(51) Int. Cl. G06F 17/00

(52) U.S. Cl. 707/102

(57) ABSTRACT

Method and apparatus are described for compensating for a linear time scale change in a received signal, so as to correctly rescale the frame sequence of the received signal. Firstly, an initial estimate of the sequence of symbols is extracted from the received signal. Successive estimates of correctly time scaled sequences of the symbols are then generated by interpolating the values of the initial estimates.

### FIELD OF THE INVENTION

The present invention relates to devices and methods of presenting information about programs in electronic program guides. Electronic program guides can be provided in such items as TVs, Set-Top boxes, VCRs and DVDs.

### BACKGROUND OF THE INVENTION

In the field of television, there are nowadays more and more channels, which a viewer can watch. It is therefore becoming more and more important to provide the television viewer with information about what programs are transmitted on what television channels and when, so that he can easily determine what he wants to watch. The same need also exists for other areas such as radio, web radio, set-top boxes and for combinations of other media.

For this reason, there has been a development of electronic program guides, which show programs to be broadcast on different channels.

EP-1028589 discloses an electronic program guide in which programs of different channels are presented in a table sorted in accordance with channel and time. In this guide, the airing time of each channel is presented in staggered fashion, i.e. the programs are not limited to a certain column, but are represented by their lengths. This means that a long program can take up much space in the horizontal direction.

There is generally a problem with these types of program guides in that long programs take up a large amount of space. This means that the program guide can include less information than what could be wanted.

### OBJECT AND SUMMARY OF THE INVENTION

In order to improve this, there are program guides in which a current/next program scheme is used instead of the time. Here, the programs are presented in accordance with a current program and a number of following programs for each program source or program provider. The space taken up for each program can therefore be made smaller and rendered independent of the time the program takes up. In this scheme there is, however, a problem with desynchronization, which is due to the fact that the programs have different lengths. This means that programs starting at the same time from different program sources can be placed in columns which are spaced far apart from each other because of the different program lengths. This makes the electronic program guide hard to look up for a user. This problem is getting worse as the number of columns with programs grows.

There is thus a need for solving the above-mentioned problem of desynchronization in electronic program guides.

It is an object of the present invention to solve the problem of desynchronization due to the different program lengths in an electronic program guide of the now/next type.

According to a first aspect of the invention, this is solved by a device for presenting data about programs from a number of program sources and a program presentation apparatus including such a device, the device for presenting data comprising: a table generator unit for generating an electronic program guide as a table comprising data about current program and following programs for each program source, a coding unit for selecting data about all programs starting within at least one first time interval and coding the selected data with an additional code, and a control unit for controlling the table generator unit and the coding unit, wherein the table generator unit is further arranged to present the selected data in accordance with the additional code.

According to the first aspect of the invention, this is also solved by a method of presenting data about programs from a number of program sources, the method comprising the steps of: receiving at least one signal containing data relating to programs of the different program sources, generating an electronic program guide as a table comprising data about current program and following programs for each program source, selecting data about all programs starting within at least one first time interval, coding the selected data with the additional code, and presenting the selected data in accordance with the additional code.

Still according to the first aspect of the invention, this is also solved by a computer program element and a computer-readable medium including such a computer program element where the computer program element comprises: computer program code means for causing the computer to execute the generation of an electronic program guide as a table comprising data about current program and following programs of a number of program sources, selection of data about all programs starting within at least one first time interval from a number of programs of different program sources, coding of the selected data with an additional code, and presentation of the selected data in accordance with the additional code.

According to a second aspect of the invention, this problem is solved by a device for presenting data about programs from a number of program sources and a program presentation apparatus including such a device, the device for presenting data comprising: a table generator unit for generating an electronic program guide as a table comprising data about current program and following programs for each source and presenting the data about the programs, using source as a first parameter and order of programs as a second parameter, a scrolling step calculation unit for determining a scrolling step size based on a third parameter, and a control unit for controlling the table generator unit and the scrolling step calculation unit and arranged to scroll data about programs of the different program sources in the table with said scrolling step size.

According to the second aspect of the invention, this is also solved by a method of presenting data about programs from a number of program sources, the method comprising the steps of: generating an electronic program guide as a table comprising data about current program and following programs for each program source, presenting the data about the programs, using program source as a first parameter and order of programs as a second parameter, and scrolling data about programs of the different program sources in the table with a scrolling step size determined by a third parameter.

Still according to the second aspect of the invention, this is also solved by a computer program element and a computer-readable medium including such a computer program element where the computer program element comprises: computer program code means for causing the computer to execute the generation of an electronic program guide as a table comprising data about current program and following programs of a number of program sources, presentation of the data about the programs, using program source as a first parameter and order of programs as a second parameter, and scrolling of data about programs of the different program sources in the table with a scrolling step size determined by a third parameter.

Use of the verb “comprise” and its conjugations is herein to be interpreted to mean the equivalent of the verb “include” and its conjugations.

The basic idea of the invention is to provide a way to make the now/next type of electronic program guide easier to use for a user in the case of desynchronization.

These and other aspects of the invention are apparent from and will be elucidated with reference to embodiments described hereinafter.

### BRIEF DESCRIPTION OF THE DRAWINGS

FIG. 1 shows a program presentation apparatus for receiving programs and data about programs.

FIG. 2 shows a block schematic diagram of different parts of the program presentation apparatus of FIG. 1.

FIG. 3 shows a block schematic diagram of an electronic program presenting apparatus according to the invention.

FIGS. 4 to 7 show different views of data presented to a user of the electronic program presenting apparatus according to the invention.

FIG. 8 shows a flow chart of a method of presenting data about programs according to a first aspect of the present invention.

FIG. 9 shows a flow chart of a method of presenting data about programs according to a second aspect of the invention.

### DESCRIPTION OF EMBODIMENTS

FIG. 1 shows a program presenting apparatus in the form of a television set 10 having a screen 14, an antenna 12 and a user input device in the form of a remote control 16. The television set is only a non-limiting example of a program presenting apparatus. It may also be, for example, a set-top box, a VCR or a radio receiver. The program presenting apparatus receives programs and data about programs via the antenna 12 from a number of program sources. In the case of television, the sources are television channels, but other types of sources are also feasible such as radio channels, video-on demand suppliers, etc. Programs and data about programs do not have to be received via the antenna and radio waves, but many other ways are feasible such as, for instance, cable, internet or intranet. The program information and the actual programs need not be received via the same medium, but the program information or data can be received, for example, via internet and the actual programs via an antenna. The remote control 16 is used by a user of the apparatus to select programs and program sources as well as to view data about program sources for selection of programs to view. The input user device does not have to be a remote control, but may be any suitable input means such as, for instance, buttons on the television set.

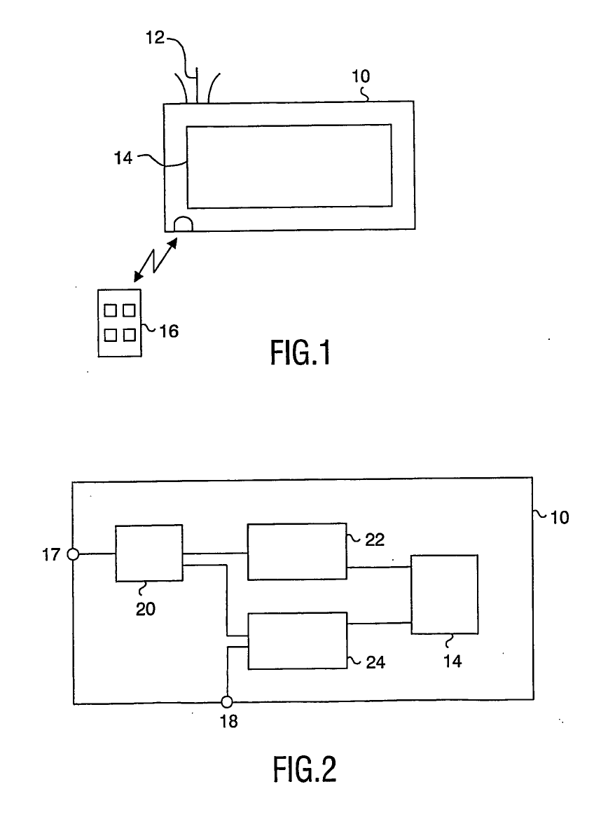

FIG. 2 shows a block schematic diagram of parts of the interior of a program presenting apparatus according to the invention. Here, a receiving unit 20 is connected to the antenna of FIG. 1 via a signal input 17 for receiving signals from different program sources. The receiving unit 20 is connected to a program handling-unit 22 and to a device for presenting data about programs, also denoted electronic program guide presenter or electronic program presenting apparatus 24. Both these units are connected to the screen 14. The receiving unit 20 forwards the actual programs to the program-handling unit 22 for possible presentation in a known way to a user of the apparatus via the screen 14. The receiving unit 20 also receives data about the programs of the program sources and forwards this data to the electronic program guide presenter 24. The program guide presenter 24 is further connected to the user input device via a user input 18 for receiving control signals by a user, and to the screen 14 for displaying data about different programs to a user. Subseqeunt steps will be described below with reference to the other drawings.

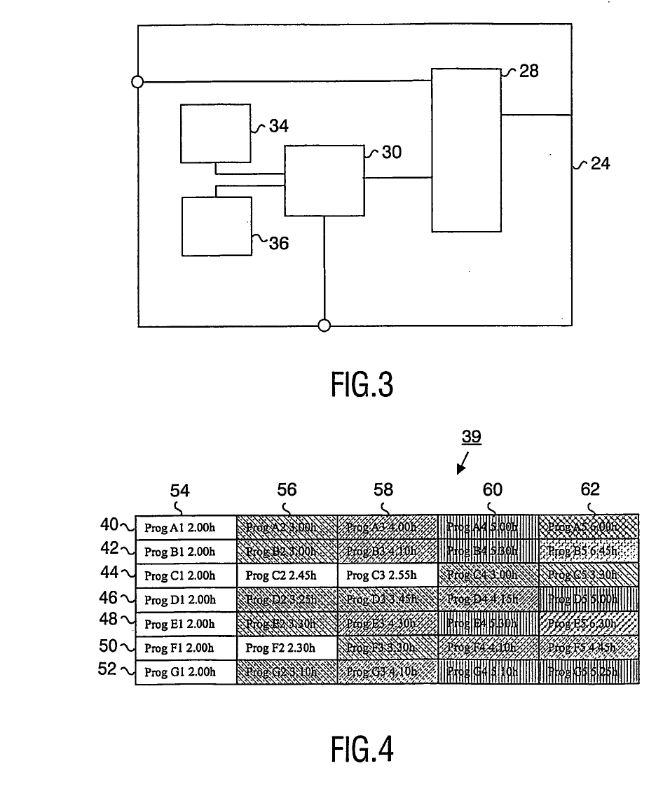

FIG. 3 shows a block schematic diagram of the electronic program presenting apparatus 24. It includes a table generator unit 28, connected to the receiving unit for receiving data about programs for the different program sources. This table generator unit 28 is connected to a control unit 30. A coding unit 34 is connected to the control unit 30. A scrolling step calculation unit 36 is connected to the control unit 30. The control unit 30 is also connected to the user input means and the control unit 30 controls the table generator unit 28, such that data about programs is presented on the screen of FIGS. 1 and 2.

FIG. 4 shows a two-dimensional table. The table contains a number of rows 40, 42, 44, 46, 48, 50, 52 sorted in accordance with program sources, where a first row 40 is intended for displaying data about programs of a first program source A, a second row 42 for displaying data about programs of a second program source B, a third row 44 for displaying data about programs of a third program source C, a fourth row 46 for displaying data about programs of a fourth program source D, a fifth row 48 for displaying data about programs of a fifth program source E, a sixth row 50 for displaying data about programs of a sixth program source F and a seventh row 52 for displaying data about programs of a seventh program source G. The table also includes a number of columns, in which a first column 54 is intended for showing a current program, a second column 56 for showing a first following program, a third column 58 for showing a second following program, a fourth column 60 for showing a third following program and a fifth column 62 for showing a fourth following program for each program source. The cells of the table therefore include, for each program source, a current program and following programs. Each cell also includes the name of the program as well as the starting time. The names are indicated by Prog A1 . . . Prog A5 for the first program source, Prog B1 . . . Prog B5 for the second program source, etc. up to Prog G1 . . . Prog G5 for the seventh program source. Different visual identifications are further associated with different first time intervals of the programs. This is indicated in different ways in the Figure. Cells with data about programs having a starting time between 3 and 4 h are shown with a first pattern, cells with data about programs having a starting time between 4 and 5 h are shown with a second pattern, cells with data about programs having a starting time between 4 and 5 h are shown with a third pattern, cells with data about programs having a starting time between 6 and 7 h are shown with a fourth pattern and cells with data about programs having a starting time between 2 and 3 h are shown with no pattern at all. It should be noted that these patterns are here only a means of indicating a common visual indication. They are actually meant to represent different colors, which is the preferred way.

A first aspect of the present invention will now be described. Data about programs of different program sources are received by table generator unit 28 under the control of the control unit 30. The table generator unit 28 then forms a table of the now/next type, where a first parameter is the program source, which makes up the rows of the table, and a second parameter is the order of programs, which are presented as columns in the table, thus a table format where the rows are the different program sources and the columns are made up of the order of programs. Thereafter, the cells of the table are filled with data about each program, which data comprises program name and starting time of the programs. A cell may also contain the time the program is ended. The coding unit 34 selects a number of first time intervals under the control of control unit 30, which are preferably of the hour size, This can be done in dependence upon the length of the programs present in the table generator unit 28. The codes are transferred to the control unit 30, which then sets these different codes to the programs of the table in the table generator unit 28. There is one code for each starting time of the programs falling within a time interval. The control unit 30 then controls the table generator unit 28 to forward the table to the screen 14, which table information includes the coding of the data concerning different programs. The screen then presents the table, with a special visual identification associated with each code. The presentation is preferable in the way of different colors for different intervals. The cells are also preferably of equal size. In this way, a now/next table, which resolves the problems of desynchronization, is provided. It is also easy for the user to see the time when different programs are broadcast in a table that may contain more information than the prior-art table.

There are several possible modifications to this first aspect of the invention. The code does not have to represent color, but other representations are also feasible, like different shapes or sizes of the cells or different types of icons. The time intervals can also be varied. They may be, for instance, half an hour long, 15 minutes long or longer than an hour. What is important is that a user can easily see what programs start within the same time span without a too complex table. Here, the starting time was used to indicate which time interval the data of a program belonged to. It is, however, possible to use the ending time instead.

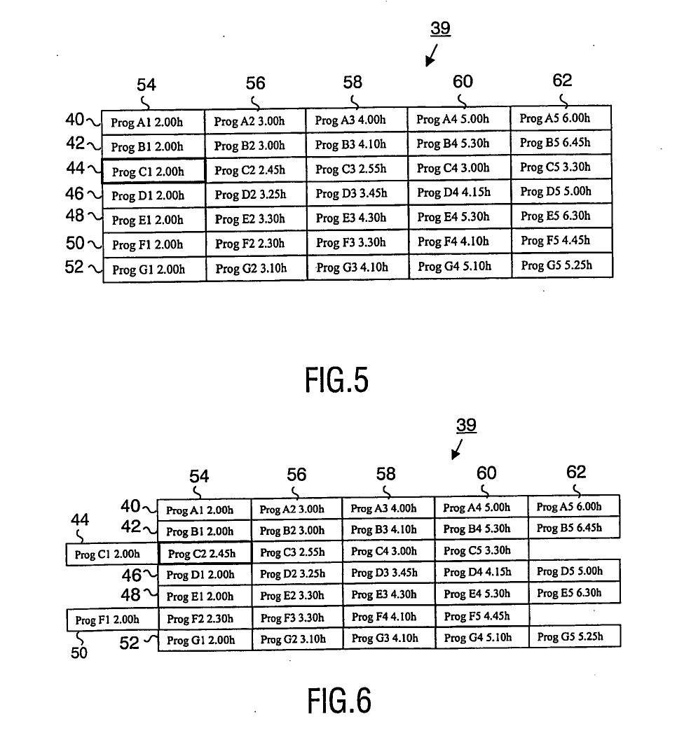

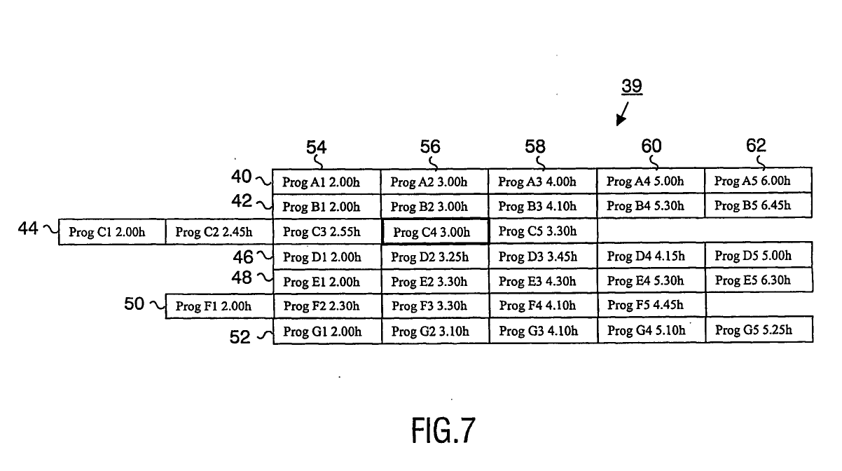

FIGS. 5, 6 and 7 show the same type of table as FIG. 4, having the same rows and columns. Here there is no different coding shown, although also these cells have the color coding described above. FIG. 5 shows exact by the same table as FIG. 4, but with a program C1 being marked. FIG. 6 shows the cell of FIG. 5, but here a cell with data about a program C2 has been marked and the third and sixth rows have been scrolled one step to the left. This means that all the programs of the third and the sixth program source have been moved one step to the left in relation to the programs of the other program sources. FIG. 7 is similar to FIG. 6, but here a program C4 of the third program source has been marked or highlighted and the row of the third program source has been scrolled another step to the left. Apart from this, all FIGS. 5 to 7 are not different from FIG. 4.

A second aspect of the invention will now be described. A user of the electronic program guide 24 can scroll the table in order to better see which programs are broadcast during the same time interval. When the user of the electronic program guide 24 therefore wants to scroll the table displayed on the screen, he actuates the remote control or some other suitable input device, which selects a certain program in the table under the control of the control unit 30. As an example, he selects the program C1 in row 44 and column 54 as shown in FIG. 5. This actuation is received by the control unit 30, which sends a signal to table generating unit 28, which in turn marks the cell as selected for display on the screen. The table generating unit sends data about the selected cell or program C1 to the control unit 30 together with the starting time of the next program C2 of the program in the same row. The control unit 30 forwards this information to scrolling step calculation unit 36, which in turn sets a scrolling step size to a second time interval starting with the starting time of the selected program and ending with the starting time of the next program of the same program source. If the user then selects to scroll the programs of the program source of the selected program, i.e. row 44, the control unit 30 checks the starting times of all other program sources and scrolls all the rows of program sources having programs with starting times within the second interval. This means that scrolling is performed while using a third parameter, time, and that scrolling is performed for programs having starting times within a second time interval. In FIG. 6, this is shown for the third row 42 and the sixth row 50. This can thereafter be repeated for as many scrolls as are necessary. Yet another scroll just having been performed for the third row is shown in FIG. 7, but here no other rows have been scrolled at the same time, as there are no other starting times in the time interval between the previously selected program, program C3, as there are no other programs starting between this program and the next program of the same channel. FIG. 7 shows where the next program has then been selected, program C4.

The described scrolling principle can be varied in many ways. The scrolling steps can be set to steps of a short fixed duration instead, for instance, 15 minutes. These steps should be small in comparison with the length of the first time interval and preferably also in relation to the normal length of the programs. The scrolling step can also be determined to be the time interval between the selected program and the first program starting after this program of any program source. The control unit can furthermore be arranged to select a best scrolling mode based upon the time relationship between the starting times of the programs of the program sources, such that a reasonable number of programs of the program sources are scrolled at the same time. If many programs were scrolled at the same time because of a large scrolling step with the stepsize described in the previous paragraph, the control unit would control the scrolling step calculation unit to set a second time interval a with short fixed duration. Likewise, for a too small scrolling stepsize of fixed duration, the control unit would control the scrolling step calculation unit to set a second time interval determined by the next program of the selected program source. The control unit would then look at the starting times of all programs after a selected program and then select the scrolling mode on the basis of how many programs have starting times in between the selected program and the next program of the same source. Such a selection is not limited to selection between these two scrolling modes but between any scrolling modes where time is used for scrolling in a now/next program guide.

Alternatively, columns can be scrolled while using the same principle as described above.

The device according to the invention is preferably implemented by a microprocessor with associated memory comprising program code for performing the invention.

In one embodiment of the invention, the program for performing the present invention is also provided on a computer-readable medium, such as a CD ROM disc or a diskette, for loading into a memory of a program guide presenter.

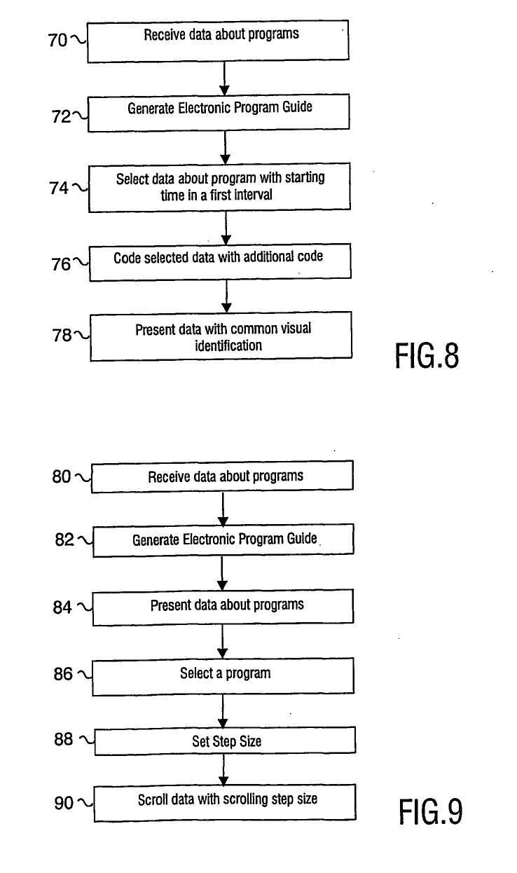

A method according to the first aspect of the invention will now be described with reference to FIG. 8, which shows a flow chart of this method. First, data about programs of a number of program sources are received, step 70. Thereafter, an electronic program guide is generated, step 72. After this, data about programs starting within a first time interval are selected, step 74. Thereafter, the selected data is coded with an additional code, step 76. The selected information is then presented with a visual indication associated with the first time interval and preferably a color, step 78. The steps 72 to 78 are then repeated for all of these first time intervals. This method can furthermore be varied in accordance with what has been described in relation to the device of the first aspect of the invention.

A method according to the second aspect of the invention will now be described with reference to FIG. 9, which shows a flow chart of this method. This method is also started with the reception of program information, step 80, and the generation of an electronic program guide, step 82. Thereafter, information about the programs is presented to a user, step 84. A program of one program source is then selected by a user, step 86, whereupon the scrolling step size is set, step 88. In one embodiment, this step size is selected as a second time interval between the starting time of the selected program and the starting time of the next program of the program source. Thereafter, data about all program sources having programs with starting times in the second interval are scrolled, step 90. Here steps 84 to 90 are repeated for possibly following scrolling steps. Also this method can be varied in accordance with what has been described in relation to the device of the second aspect of the invention. Also this method can be combined with a scrolling mode selection as described above in relation to the device.

Devices and methods for solving the problem of desynchronization of a now/next table are obtained with the present invention.

Use of the verb “comprise” and its conjugations is not to be interpreted as limiting. It does not exclude other elements that are not mentioned. Furthermore, the use of a time interval does not exclude more than one interval and the use of a unit does not exclude the use of several units.

The scope of the invention is not to be limited by the description, but only by the appendent claims.

1. A device for presenting data about programs from a number of program sources, the device comprising:
a table generator unit for generating an electronic program guide as a table comprising data about current program and following programs for each program source,
a coding unit for selecting data about all programs starting within at least one first time interval and coding the selected data with an additional code, and
a control unit for controlling the table generator unit and the coding unit, wherein the table generator unit is further arranged to present the selected data in accordance with the additional code.

2. A device as claimed in claim 1, wherein the table generator unit is arranged to generate the table with rows sorted in accordance with source and columns sorted in accordance with next program of each source.

3. A device according to claim 1, wherein the table generator unit is arranged to present the data using a common visual identification for the time interval.

4. A device according to claim 3, wherein the common visual identification is a color associated with the time interval.

5. A device according to claim 1, wherein the table generator unit is further arranged to present the data about the programs, using source as a first parameter and order of programs as a second parameter, the device further including a scrolling step calculation unit arranged to determine a scrolling step size based on a third parameter and the control unit being arranged to control the scrolling step calculation unit and scrolling data about programs of the different program sources in the table with said scrolling step size.

6. A device for presenting data about programs from a number of program sources, the device comprising:
a table generator unit for generating an electronic program guide as a table comprising data about current program and following programs for each source and presenting the data about the programs, using source as a first parameter and order of programs as a second parameter,
a scrolling step calculation unit for determining a scrolling step size based on a third parameter, and
a control unit for controlling the table generator unit and the scrolling step calculation unit and arranged to scroll data about programs of the different program sources in the table with said step size.

7. A device according to claim 6, wherein the third parameter is time.

8. A device according to claim 7, wherein the step size is set to a second time interval and, for each scrolling step, the control unit is arranged to scroll all data concerning the programs of a program source if the data about a program of said program source has a start or stop time within the second time interval.

9. A device according to claim 8, wherein the second time interval is set to a short fixed duration in comparison with a first time interval.

10. A device according to claim 8, wherein the scrolling step calculation unit is arranged to set the second time interval as the time between the starting time of a selected program and the starting time of any program having a starting time closest to and after the starting time of the selected program.

11. A device according to claim 8, wherein the scrolling step calculation unit is arranged to set the second time interval as the time between the starting time of a selected program and the starting time of the next program of the same program source.

12. A device according to claim 8, wherein the control unit is arranged to control, on the basis of the time relationship between the starting times of the programs, the scrolling step calculation unit to set the second time interval, such that a reasonable number of programs of program sources are scrolled at the same time.

13. A program presentation apparatus for presenting programs from a number of program sources, the apparatus comprising:
a receiving unit for receiving at least one signal containing data relating to programs of the different program sources,
a table generator unit for generating an electronic program guide as a table comprising data about current program and following programs for each program source,
a coding unit for selecting data about all programs starting within at least one first time interval and coding the selected data with an additional code, and
a control unit for controlling the table generator unit and the coding unit, wherein the table generator unit is further arranged to present the selected data in accordance with the additional code.

14. A program presentation apparatus for presenting programs from a number of program sources, the apparatus comprising:
a receiving unit for receiving at least one signal containing data relating to programs of the different sources,
a table generator unit for generating an electronic program guide as a table comprising data about current program, and following programs for each program source and presenting the data about the programs, using source as a first parameter and order of programs as a second parameter,
a scrolling step calculation unit for determining a scrolling step size based on a third parameter, and
a control unit for controlling the table generator unit and the scrolling step calculation unit and arranged to scroll data about programs of the different program sources in the table with said step size.

15. A computer program element comprising: computer program code means for causing the computer to execute
generation of an electronic program guide as a table comprising data about current program and following programs of a number of program sources,
presentation of the data about the programs using program source as a first parameter and order of programs as a second parameter, and
scrolling of data about programs of the different program sources in the table with a scrolling step size determined by a third parameter.

16. A computer program element as claimed in claim 15, embodied on a computer-readable medium.

17. A computer program element comprising: computer program code means for causing the computer to execute
generation of an electronic program guide as a table comprising data about current program and following programs of a number of program sources,
selection of data about all programs starting within at least one first time interval from a number of programs of different program sources,
coding of the selected data with an additional code, and
presentation of the selected data in accordance with the additional code.

18. A computer program element as claimed in claim 17, embodied on a computer-readable medium.

19. A method of presenting data about programs from a number of program sources, the method comprising the steps of:
receiving at least one signal containing data relating to programs of the different program sources,
generating an electronic program guide as a table comprising data about current program and following programs for each program source,
selecting data about all programs starting within at least one first time interval,
coding the selected data with the additional code, and
presenting the selected data in accordance with the additional code.

20. A method according to claim 19, wherein the step of generating comprises generating the table with rows sorted in accordance with program source and columns sorted in accordance with next program of each program source.

21. A method according to claim 19, wherein the step of presenting comprises presenting the programs within the time interval, using a common visual identification for the time interval.

22. A method according to claim 21, wherein the common visual identification is a color associated with the time interval.

23. A method of presenting data about programs from a number of program sources the method comprising the steps of:
generating an electronic program guide as a table comprising data about current program and following programs for each program source,
presenting the data about the programs using program source as a first parameter and order of programs as a second parameter, and
scrolling data about programs of the different program sources in the table with a scrolling step size determined by a third parameter.

24. A method according to claim 23, wherein the third parameter is time.

25. A method according to claim 24, wherein the step size is set to a second time interval and the step of scrolling comprises, for each scrolling step, scrolling all data concerning the programs of a program source if the data about a program of said program source has a start or stop time within the second time interval.

26. A method according to claim 25, wherein the second time interval is of a short fixed duration in comparison with the length of a first time interval.

27. A method according to claim 25, further comprising the step of selecting a program, which selection sets the second time interval as the time between the starting time of the selected program and the starting time of any program having a starting time closest to and after the starting time of the selected program.

28. A method according to claim 25, further comprising the step of selecting a program, which selection sets the second time interval as the time between the starting time of the selected program and the starting time of the next program of the same program source.

29. A method according to claim 25, wherein the second time interval setting is selected on the basis of the time relationship between the different programs of the program sources, such that a reasonable number of programs of program sources are scrolled at the same time.
